(19) United States
(12) Patent Application Publication
(10) Pub. No.: US 2008/0189528 A1
(43) Pub. Date: Aug. 7, 2008

(54) System, Method and Software Application for the Generation of Verification Programs

(75) Inventor: James H. Robinson, New York, NY (US)

Correspondence Address: LEGAL DEPARTMENT;MIPS TECHNOLOGIES, INC., 1225 CHARLESTON ROAD, MOUNTAIN VIEW, CA, 94043, US

(73) Assignee: MIPS Technologies, Inc., Moutain View, CA (US)

(21) Appl. No.: 11/670,876

(22) Filed: Feb. 2, 2007

(51) Int. Cl. G06F 9/00

(52) U.S. Cl. 712/226; 712/227; 712/E09.001

(57) ABSTRACT

A system, method and software application according to the present invention creates complex, interesting, self checking and sturdy verification programs. A self-checking random verification program automatically generates appropriate register and memory reference values, inserts checkpoints and gathers and reports results to test CPU designs. With appropriate templates and simulator, the SRVP framework is largely independent of the CPU architecture and can be utilized to generate randomly generated self-checking verification programs for any CPU architecture and any CPU instruction set.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In the process of designing integrated circuits, it is necessary for the circuit designer to test and verify the correctness of the integrated circuit design at all stages of the design and manufacturing process.

One particular type of integrated circuit includes a central processing unit (CPU), also variously known as a processor, a microprocessor, a ‘core’ or a device whose operation can be controlled by executing instructions. A CPU may be programmed (using a set of instructions) to perform any one of a variety of tasks, from controlling machinery to processing data. In the context of the present patent application, the term CPU is to be construed broadly, to cover any type of CPU. In particular, the term CPU is to be construed to include multi-threaded or multi-core CPUs where multiple threads may access one or more shared resources including memory and registers.

CPUs have become increasingly complex over time, by virtue of a consumer driven requirement for more sophisticated processing ability across a diverse range of applications. Many CPUs now utilize sophisticated instruction sets, including instruction sets that are optimized to perform a particular task (e.g. rendering multimedia content).

Therefore, as the complexity increases, the tests required to ensure that the CPU architecture is correctly implemented in a CPU design and operates in a predictable manner also becomes a more complex and sophisticated task.

One way to test a CPU design is to write a ‘test’ program (also referred to as a verification program) that attempts to test some or all of the available functions of the CPU. The verification program is commonly a hand written program, written by a CPU designer (in many cases an engineer) and specifically tailored to test a portion of the CPU. Since they are simply self checking assembly programs, they can be run on any architecture compatible CPU (hardware or simulation). Unfortunately, because the test programs are relatively small, static pieces of code, passing all tests is not a sufficient condition to prove that a particular design complies with the architecture in all respects, or is free of bugs.

Another type of verification program generates random instruction sequences. Random code sequences can probe corners of architectural behavior far beyond what can be achieved using hand written, directed tests. After the very early stages of core development, a CPU will typically pass all of the hand coded programs, but the program that implements random instruction sequences will continue to find large number of bugs. Unfortunately, this program can only be run within an RTL simulation environment, which is slow, limits the number of tests that can be run, costly in most cases and impossible to run if synthesizeable RTL is not available. Note that RTL refers to an abstract, logical description (often specified via a hardware description language, or “HDL”, such as Verilog or VHDL) rather than a discrete netlist of logic-gate (boolean-logic) primitives or a higher level abstraction of the CPU.

When a random program is used to test the behavior of a CPU, it is necessary to have some method to determine whether the CPU under test has executed that random program correctly. One way to do this is to execute the program on both the CPU under test, and on a reference model (typically, a CPU simulator), and compare the results. The comparison may be done by comparing the state of registers and memory in the two models at the end of the test. Alternatively, if trace output is available, the two models may be compared on an instruction by instruction basis. Generating this type of random program is relatively straightforward, since the task of determining correct CPU behavior is delegated to the external reference model. One disadvantage of the technique is that it is necessary to create an external reference model which behaves correctly under all situations. Also, when no trace data is available (as is typical for real hardware), the ability to compare the behavior of the CPU and the reference model is limited. Further, there are significant constraints on the randomness of the behavior that can be generated. For example, to prevent load or store instructions from reading or writing reserved regions of memory, restrictions may be required when computing the base register value for the load or store.

Since verification programs are generally small, static pieces of code that do not change over time, a verification program will not always adequately test all of the possible conditions that can occur within a complex CPU when a particular instruction is executed.

Moreover, current verification programs cannot always adapt easily to changing CPU designs and therefore become less useful as CPUs become more complex. For example, even though the basic instruction sets in the CPU architecture may be backward compatible, older verification programs cannot be used to meaningfully test newer extensions to the instruction set.

### SUMMARY

The embodiments of the present invention described herein provides a self-checking verification system, method and software application that are each capable of randomly generating a mix of instructions suited to testing a simulated, prototype or production (physical) central processing unit (CPU).

### BRIEF DESCRIPTION OF THE DRAWINGS

Features of the present invention will be presented in the description of an embodiment thereof, by way of example, with reference to the accompanying drawings, in which:

FIG. 1 is a computing system capable of operating a software application in accordance with an embodiment of the present invention;

FIG. 2 is a diagram that depicts the components of a verification program in accordance with an embodiment of the present invention;

FIG. 3 is a schematic diagram that depicts the modules of a software application utilized to construct the verification program of FIG. 2; and

FIG. 4 is a flow chart that describes the steps of a methodology utilized to construct a verification program in accordance with an embodiment of the present invention.

### DETAILED DESCRIPTION

The embodiments described herein provides a self-checking verification system, method and software application that are each capable of randomly generating a mix of instructions suited to testing a simulated, prototype or production (physical) central processing unit (CPU).

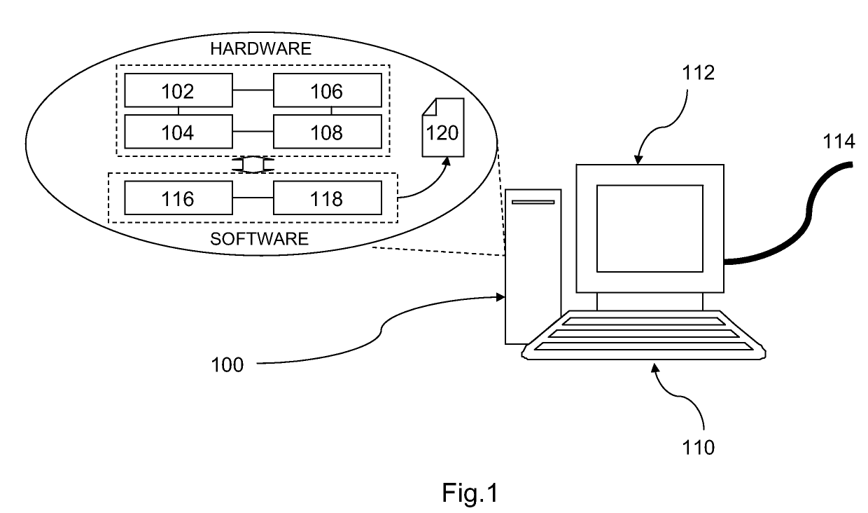

The self-checking verification system, in one embodiment, is a software application arranged to be executed on a computing system, such as the computing system of FIG. 1. At FIG. 1 there is shown a schematic diagram of a computing system 100 suitable for use with an embodiment of the present invention. The computing system 100 may be used to execute applications and/or system services such as deployment services in accordance with an embodiment of the present invention.

The computing system 100 preferably comprises a processor 102, read only memory (ROM) 104, random access memory (RAM) 106, and input/output devices such as disk drives 108, keyboard 110, (or other input peripherals such as a mouse, a tablet, a trackball, a touch sensitive screen, or any other suitable device), display 112 (or any other output peripheral such as a printer, a speaker, or any other suitable output device) and communications link 114. The computer includes programs that may be stored in ROM 104, RAM 106, or disk drives 108 and may be executed by the processor 102. The communications link 114 connects to a computer network but could be connected to a telephone line, an antenna, a gateway or any other type of communications link.

Disk drives 108 may include any suitable storage media, such as, for example, floppy disk drives, hard disk drives, CD ROM drives or magnetic tape drives. The computing system 100 may use a single disk drive or multiple disk drives. The computing system 100 may use any suitable operating system 116, such as Microsoft Windows™ or Unix™.

It will be understood that the computing system described in the preceding paragraphs is illustrative only and that the presently described embodiment or other embodiments which fall within the scope of the claims of the present application may be executed on any suitable computing system, which in turn may be realized utilizing any suitable hardware and/or software.

In FIG. 1, the software application 118 includes a plurality of modules. The modules are described in more detail below.

The software application 118 is arranged to generate a verification program 120 that includes a randomly generated mix of instructions. The randomly generated mix of instructions may then be utilized to test a simulated or actual CPU. The verification program 120 of the embodiment described herein, is referred to in the following description as a Self-checking Random Verification Program (SRVP).

### SRVP Overview

The purpose of a SRVP is to test a CPU to determine whether the CPU behaves correctly in accordance with the proposed CPU architecture and CPU instruction set. In the embodiment described herein, all references to a CPU refer to a CPU that implements a MIPS compatible architecture and correspondingly, all references to a CPU architecture are references to a MIPS compatible architecture.

The MIPS® architecture, developed by MIPS Technologies, a company based in Mountain View, Calif., U.S.A., is modeled around a RISC (Reduced Instruction Set) CPU architecture first developed by MIPS® Technologies in the early 1980s. The earlier MIPS® architectures were 32-bit implementations (with 32-bit wide registers and data paths), while later versions were expanded to 64-bit implementations. One notable feature of the MIPS® architecture is that the basic instruction set has remained compatible between successive architectures. Five backward-compatible revisions of the MIPS® instruction set exist at the filing date of this application, namely MIPS I, MIPS II, MIPS III, MIPS IV, and MIPS 32/64. However, with the present invention, verification programs can be readily used to meaningfully test future extensions to the instruction set. It will be understood that the embodiments described herein, and the invention defined by the scope of the claims, can be applied to any type of CPU and is not limited to the MIPS instruction set.

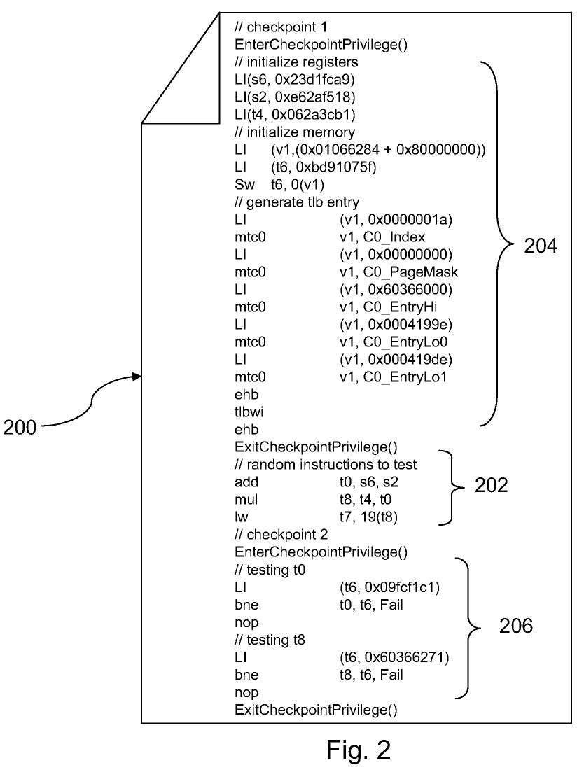

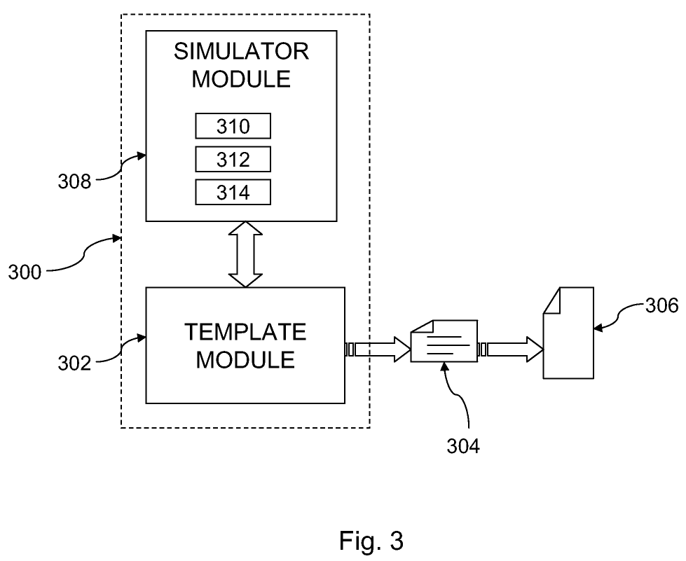

The structure of the SRVP is described with reference to FIG. 2. The SRVP 200 contains two types of instructions, namely test instructions 202 and checkpoints 204 and 206. The test instructions 202 are random instructions that are generated by a random instruction generator (described with reference to FIG. 3). The checkpoints 204 contain code that verifies, as the SRVP is executed, that all the registers and memory segments, which have been modified by the random instructions, contain the correct value after the instruction (or sub-set of instructions) has been performed.

The checkpoints can also contain code that initializes memory and registers to a particular state prior to the execution of the random instructions. In the example, checkpoint 1 (204) contains initialization code, and checkpoint 2 (206) contains register checking code. In an example containing more than one group of random instructions, a single checkpoint may include both register testing code for the previous group of random instructions and register initialization code for the next group of randomly generated instructions.

If all checkpoints are passed without failures, execution reaches a pass subroutine, which reports that the SRVP has completed successfully. Any run that does not conclude by reaching the pass subroutine within a certain length of time is considered to be a failed run. For instance, a bug may, in principle, cause execution to branch to an arbitrary memory location from which execution continues indefinitely.

A SRVP is provided in the assembly language of the CPU. For example, a SRVP written for the MIPS language contains only MIPS compatible instructions. As such, a SRVP can be run on any device that supports the architecture of the CPU (which can include a physical CPU or a CPU simulator). A SRVP is not dependent on any features such as trace support or the availability of an external reference.

### SRVP Generation System

The SRVP generation system 300, as shown in FIG. 3, is a flexible framework for creating SRVPs of the type described above. A user makes use of the SRVP system 300 to create different types of SRVPs to cover one or more sections of the architecture of a CPU.

The SRVP generation system 300 includes a template module 302, which is capable of generating a SRVP. The template module 302 is a program that generates a sequence of random instructions 304 which are utilized by the SRVP system to create a verification program (an instance of a SRVP) 306. The template module 302 includes a set of rules, which describes the manner in which a random sequence of instructions 304 are to be constructed into the verification program 306. The rules are set and controlled by a user.

For example, the user may create a sequence that contains a large number of load and store instructions in order to place a particular stress on the CPUs load/store architecture. Alternatively, the user may choose a semi-random sequence, such as a random load, followed by a random arithmetic instruction, followed by a random store instruction, then a loop to repeat the instructions a number of times. The SRVP system 300 does not place any constraints on the type or relative order in which the random instruction sequence is generated, giving the user maximum flexibility to create tests that seek to provide broad coverage of the CPU's behavior.

The random instruction sequence 304 generated by the template module 302 will be inserted into the verification program 306, interspersed with checkpoints (see FIG. 2). The checkpoints are instructions that either initialize register and memory values before an instruction is executed, or determine whether the random instructions were executed correctly by the CPU. The checkpoints are created automatically, based on rules contained within the template module 302 and information received from a CPU simulator module 308.

### CPU Simulator

The SRVP system 300 also includes a CPU simulator 308 that is capable of receiving an instruction and simulating all measurable values of the CPU after the instruction has been executed. The measurable values include the register and memory values. Therefore, necessary information required to generate a checkpoint is available. To insert a checkpoint, the user submits a request to the CPU simulator 308 to generate the necessary checkpoint code. The user may choose the frequency of checkpoints in the random instruction sequence.

The CPU simulator 308 contains storage elements 310 representing all of the CPUs registers 312, plus external memory 314 directly referenced by the CPU. In the following paragraphs, a MIPS compatible architecture is used as an example. In a MIPS compatible architecture, the registers 312 are referred to as the Privileged Resource Architecture (PRA).

The simulator 308 is capable of determining the effect any given instruction has on the CPU, including the expected output of the CPU, the state of all the registers, and the state of the external memory directly controlled by the CPU. In the embodiment described herein, the simulator 308 provides the reference model of the MIPS architecture that SRVPs use to decide what the correct behavior of CPUs executing the generated tests should be.

The CPU simulator may be a distinct software module, or may be integrated into the SRVP system.

When a particular instruction is provided to the simulator, the simulator determines what happens ‘if’ the instruction is executed. In other words, the template module provides a randomly generated instruction to the simulator, and receives feedback on the expected status of the CPU if the instruction were to be executed.

When an instruction is randomly generated, there is a significant probability that the randomly generated instruction is of a category of instructions that place the CPU into an unpredictable or uninteresting state.

For example, there are certain disallowed instruction sequences, for which the MIPS architecture cannot predict the resulting state of the CPU. The following instruction sequence can cause a MIPS CPU to be placed into an undefined state:

| | |
|---|---|
| mul | t3, t0, v0 |
| mfhi | v1 |
| jr | v1, label |
| nop | |

Here the mul instruction places the result directly into a register, leaving the hi/lo memory spots in an unpredictable state. Therefore, an instruction to move a value from hi (mfhi) sets the register v1 to an unpredictable value, so the subsequent instruction to jump from the address in v1 (jr v1) causes the program to jump to an unknown address. This can cause an exception or cause undesirable results, as execution may continue from any conceivable address in the address space.

In other words, randomly generated instructions may result in behavior that is destructive and unpredictable and therefore uninteresting from a verification perspective.

In another example, randomly generated instructions can cause a section of code in memory to be overwritten with a random value. This causes behavior that cannot be predicted by the CPU simulator. Thus, the SRVP system, in accordance with the present invention, includes a checking mechanism that prevents instructions that would put the CPU into an unpredictable state.

The checking mechanism operates by reporting to the template module, on receipt of an instruction from the template module, the result of the execution of the instruction.

The result is reported as belonging to one of four types, namely unpredictable, exception, branch and normal.

Unpredictable: The instruction, if executed, would produce an unpredictable response (as discussed above). As such, there is no discernable benefit from including such an instruction in the SRVP.

Exception: The instruction would result in an exception (with a particular entry vector and PRA state). If the instruction is to be included the SRVP, the SRVP must also include an exception handler to deal with the exception in question.

The exception handler checks, for each occurrence of an exception, that execution continues from the correct program address and that all modifications to the CPU's state resulting from the exception have occurred. The exception handler then causes program execution to jump to a designated address at which random instruction generation continues.

Branch: The instruction results in a branch. If the instruction is to remain in the SRVP, subsequent instructions must be aware that execution will continue from the branch target address. An example of a branch instruction is “beq t1, t2, label”. If the values in the registers t1 and t2 are equal, then the simulator reports that the expected result is a branch. Therefore, if the user chooses to insert this instruction into the SRVP, appropriate instructions must be inserted into the SRVP to handle the branch.

Normal: The instruction may update PRA state but causes no change in execution flow. This instruction may remain in the SRVP without any modification.

Depending on the result type (i.e. unpredictable, exception, branch or normal) the user can choose whether or not to include the instruction in a SRVP. For instance, if the user wants to generate a SRVP with a low proportion of exceptions, they may choose not to insert an instruction that would generate an exception.

However, some instructions that produce unpredictable results may be rendered predictable through the insertion of some additional code into the SRVP. The SRVP system includes a number of routines that assist in reducing the number of instructions that generate unpredictable results or uninteresting exceptions.

### Change Information for Unpredictable Expected Status

The SRVP system provides change information. Change information is information that describes the changes that can be made to the SRVP to render the expected status of the SRVP to a predictable type. Change information may include instructions that change the CPUs state prior to an instruction being executed, so that when the instruction is executed, a predictable result is ensured. Change information may also include information that is used to set a register value or a memory address such that the execution of an instruction does not result in an exception.

The necessary changes can take any one of many forms, but are generally concerned with changing the CPU state, in one manner or another, through the insertion of a checkpoint. The random instruction sequence does not therefore have to be interrupted by the process of rendering instructions predictable. As a result, SRVP helps the template generator create unconstrained random instruction sequences that generate predictable, non exceptional results.

The feature of providing change information is best illustrated through the provision of a specific example. One specific example is the treatment of load and store instructions in the random instruction sequence.

Completely random load and store instructions are liable to be problematic for random code. In the MIPS architecture, the address for the load or store is a 16 bit immediate offset from the value contained in a base register (or for indexed load/store, a value computed by adding together two registers). Ideally, the value(s) contained in the base register(s) should be completely random (which would provide a better probability of all possible addresses being tested), yet have been computed as a result of arbitrary prior instructions.

However, a load or store instruction constructed from an arbitrary base address cannot produce a predictable result in every instance, unless the memory and core PRA have been set up in a particular manner.

Therefore, to take advantage of the power of randomly generating a load and store operation, while concurrently ensuring that a predictable result is achieved, the SRVP system utilizes a technique dubbed ‘Retrospective Translation Lookaside Buffer (TLB) entry generation’.

The MIPS architecture supports multiple virtual address spaces, each divided into segments. In some embodiments, a MIPS CPU may include a memory management unit that translates all virtual addresses generated by the CPU through the Translation Lookaside Buffer (TLB), which is a fully-associative cache of recently translated virtual page numbers. That is, each TLB entry holds a virtual page number, an address space identifier, and the page frame number.

Therefore, where a load/store instruction references a virtual memory address, the corresponding physical memory address is computed via a mapping contained in the CPU's TLB. This can be quite a common occurrence in some CPU architectures. For example, in a MIPS32 CPU with a TLB, 75% of the total address space available to the CPU is accessed via the TLB.

When a load or store instruction encounters a virtual memory address, and no corresponding entry is currently found in the CPUs TLB, the SRVP software application reports that the result of the requested instruction would be a TLB ‘miss’ exception, if executed.

Furthermore, the simulator also provides information on the type of TLB entry that would need to be generated in order for the address to be mapped to a region of memory that is available to the test to read or write. The template module may then create the suggested mapping by adding appropriate instructions at a checkpoint prior to the location of the instruction in the SRVP. When the template module requests the instruction again, the simulator now sees the mapping, and generates a predictable, non exceptional result.

Other techniques are also utilized to ensure that predictable results are obtained. For example, the SRVP system also provides a technique by which memory is correctly initialized. The technique is dubbed ‘Retrospective Memory Initialization’.

When a load attempts to read from a word of physical memory that has not previously been initialized, the CPU simulator instructs the template module that the result would be predictable if a value was stored to that location at some prior point in the test. The template module can then retrospectively initialize the word of physical memory by inserting appropriate instructions before the load attempt appears.

A similar technique may also be used in situations where address alignment exceptions are likely or where a SRVP may accidentally access a reserved area of memory. That is, if a random memory location is chosen by the template module, the random location may not take into account the granularity of the memory space, thereby causing exceptions. Similarly, a randomly generated memory location may accidentally access a reserved area of memory, also causing unpredictable results. In a third example, a user may want to force a SRVP to access a particular area of memory. This can be achieved by requiring the simulator to provide an Immediate Offset Choice. In other words, the simulator may instruct the template module to use a particular immediate value for the load or store.

Using these techniques, loads and stores can be inserted randomly into the SRVP with no particular constraints on how the base register value has been computed. By constructing and inserting checkpoints into the SRVP prior to the load or store instructions, utilizing the techniques of retrospective TLB entry generation, retrospective memory initialization, and choice of immediate offset, a large proportion of the random loads and stores can result in predictable, non exceptional results, targeting desired regions of physical memory and caches.

Note that the techniques described herein may also be applied to multi-threaded and multi-core systems, where one or more resources such as memory or registers are shared between different threads of execution within the CPU. For a CPU with multiple threads of execution, the generator creates a separate stream of random instructions for each thread of execution. Appropriate code is inserted into the SRVP to ensure that each of the system's threads executes the appropriate sequence of random instructions. In cases where mutiple threads access the same storage elements (which may be CPU registers or external memory), the effect of accessing those storage elements may be unpredictable unless certain synchronizing instruction sequences are inserted to the SRVP to guarantee the order in which the access of the shared memory elements occurs between threads. When such unpredictable accesses occur, the simulator provides change information to the generator suggesting what kind of synchronizing events are required to render the result of the access to the shared storage element (memory or registers) predictable. By inserting the suggested syncronization events to the SRVP, the generator can create random multi-threaded instruction sequences with predictable results.

### Example of SRVP Flow

The methodology of the embodiment described herein is best described with reference to the following simplified example. It will be understood that a ‘real life’ example may generate thousands or potentially millions of instructions and the example provided herein is simplified for reasons of clarity and understandability only.

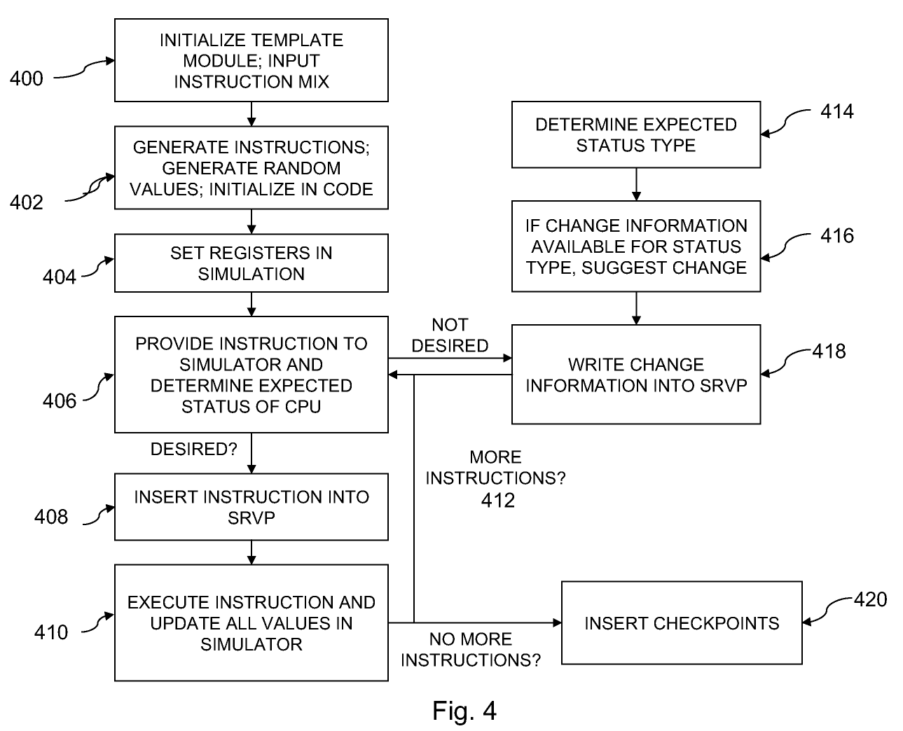

Referring to FIG. 4, in a first step (step 400), a user initiates the template module, and optionally provides a profile (i.e. information about the mix of instructions the user wishes to utilize). For example, the user may wish to construct a test with a high number of load/store instructions. Once the desired profile has been provided, the template randomly chooses a set of instructions that fit the profile, allocates a random value to each register which is used as an input to each of the instructions, and generates the appropriate code to initialize all variables to the randomly chosen values (step 402). For example, the template may choose the three instructions given below:

| | |
|---|---|
| add | t0, s6, s2 |
| mul | t8, t4, t0 |
| lw | t7, 19(t8) |

The first instruction, an “add” instruction has two input registers and one output register, and executing the add instruction causes the value in the output register to be set to the sum of the two input register values. When an add instruction is chosen for insertion into the SRVP's random instruction sequence, the SRVP selects random initial values to allocate to each of the add instruction's input registers. Note that the randomly chosen values are selected from a specially designed, non uniform distribution of values that are selected to modify the possibility of hitting certain corner cases, such as overflow. Specially designed refers to numbers that are clustered around the highest possible value and the lowest possible value or numbers that have binary patterns that may trigger edge effects on the arithmetic logic unit in the CPU. For certain random instruction sequences, the value of one or both of the add instruction's input registers will be computed as the output of a previous instruction in the random sequence, in which case the allocation of a random input value for that register can be skipped.

The template generates assembly code to initialize all values (step 406). The following code is placed at the beginning of the first checkpoint:

LI(s6, 0x23d1fca9)
LI(s2, 0xe62af518)
LI(t4, 0x062a3cb1)

The simulator is then instructed to set all the appropriate registers to the corresponding values (step 404). In the example given, the instruction ‘LI’ is an assembly macro that loads an immediate value into a register.

The first instruction is provided by the template to the simulator (step 406), to determine the expected status of the simulator (CPU) after the instruction is executed, thereby determining whether the randomly generated instruction generates a predictable and interesting result. In other words, the instruction “add t0, s6, s2” is passed to the simulator. The simulator, in turn, preprocesses the instruction and determines that the result would be normal execution, with t0 set to 0x09fcf1c1.

The simulator returns the determination to the template module. As the result is normal execution (step 408), the template writes the instruction into the SRVP (step 410) and instructs the simulator to simulate the effect of the instruction and therefore set the value of all internal storage elements as required (step 412), which in the example, requires the register representing t0 to be set to 0x08fcf1c1.

The process then returns to determine whether there are any further instructions that require checking (step 412) and locates the second instruction. The template module provides the instruction “vmul t8, t4, t0” to the simulator and the simulator preprocesses the instruction (step 406), to determine the expected status of the simulator after the instruction is executed. In the present example, the instruction would result in normal execution, with t8 set to 0x60366271 and the HI/LO accumulator set to an unpredictable state.

As a result of the information received from the simulator, the template inserts the instruction into the verification program (step 408). The simulator subsequently processes the instruction and sets the value of its internal storage element representing t8 to 0x60366271 and declares that the HI/LO accumulator is in an unknown state (step 410).

The process then returns to determine whether any further instructions need to be tested (step 412) and locates the third instruction. The template provides the instruction “lw t7, 19(t8)” to the simulator to preprocess the instruction and returns the expected status of the CPU (step 406). In the present example, the instruction would result in a TLB miss exception, from virtual address 0x60366284.

For the purpose of the present example, it is assumed that the template is required to generate a non-exceptional load rather than a TLB miss. Therefore, before the instruction is written to the SRVP, the instruction is categorized into a type (step 414) and then, if available, change information is generated (step 416) to overcome the TLB miss.

In the example given, the change information is the insertion of code into the previous checkpoint to generate a TLB mapping for the virtual address in question.

The template selects a currently unused TLB entry at random, updates the state of the TLB in the simulator to reflect the new mapping and inserts the following mapping generation code into the previous checkpoint:

| | |
|---|---|
| LI | (v1, 0x0000001a) |
| mtc0 | v1, C0_Index |
| LI | (v1, 0x00000000) |
| mtc0 | v1, C0_PageMask |
| LI | (v1, 0x60366000) |
| mtc0 | v1, C0_EntryHi |
| LI | (v1, 0x0004199e) |
| mtc0 | v1, C0_EntryLo0 |
| LI | (v1, 0x000419de) |
| mtc0 | v1, C0_EntryLo1 |
| ehb | |
| tlbwi | |
| ehb | |

In the fragment of code given above, v1 is a register that has been reserved by the template for use in checkpoints. The mapping details are chosen so that the virtual address maps to a physical address that is accessible to the test.

The template then provides the new instruction, namely “lw t7, 19(t8)” to the simulator (step 406) for preprocessing to determine the expected status of the simulator if the instruction were to be executed. The simulator is aware that the virtual address in question maps to a physical address of 0x01066284. However, the simulator has no knowledge of the value stored at this memory location. Therefore, the simulator reports that the result of the load instruction would be to set the register t7 to an unknown value. As the result is unknown, the instruction type is determined (step 414) and the simulator provides suggested change information (step 416) which renders the result predictable, by writing a value to physical address 0x01066284.

In response to the suggestion, the template inserts instructions (step 418) in a prior checkpoint to initialize the memory word 0x01066284 to a random value, and informs the simulator that the memory word has been initialized to this value. This is achieved by the insertion of the code fragment shown below:

| | |
|---|---|
| LI | (v1,(0x01066284 + 0x80000000)) |
| LI | (t6, 0xbd91075f) |
| sw | t6, 0(v1) |

The checkpoint code fragment uses an unmapped virtual address to write a value to the physical address in question. The checkpoint will be executed at the necessary privilege level to access the unmapped segment of the address space.

The process is again iterated, with the template passing the instruction “lw t7, 19(t8)” to the simulator for preprocessing to determine the expected status of the simulator (step 406). The simulator reports that the result would be normal execution, with t7 set to 0xbd91075f.

The template subsequently inserts the instruction into the SRVP (step 408). The assembly instruction lw t7, 19(t8) is passed to the simulator to simulate the expected status of the simulator if the instruction was executed. The simulator updates all values in the simulator (step 410), by setting the value of the internal storage element representing t7 to 0xbd91075f and passing the TLB mapping index 0x1a to the template. In turn, the template reserves the TLB mapping provided by the simulator. The simulator now cannot overwrite this TLB mapping retrospectively. The TLB mapping may only be overwritten at a point in the verification after the generated load instruction.

The template subsequently requests the generation of a new checkpoint (step 420). In this checkpoint, the output values of all the instructions executed are checked. The simulator generates the following code fragment for the template to insert into the verification program:

| // testing t0 | |
|---|---|
| LI | (t6, 0x09fcf1c1) |
| bne | t0, t6, Fail |
| nop | |
| // testing t8 | |
| LI | (t6, 0x60366271) |
| bne | t8, t6, Fail |
| nop | |
| // testing t7 | |
| LI | (t6, 0xbd91075f) |
| bne | t7, t6, Fail |
| nop | |

In the example, t6 is a register that is reserved for use in checkpoints. “Fail” is a subroutine that reports failure. If any future TLB mappings were to be generated by the template, they would be added at the end of the current checkpoint. Therefore, it is no longer necessary for the template to reserve the 0x1a TLB entry that has just been used, since overwriting the entry will not affect the behavior of the previous “lw” instruction.

Therefore, as a result of steps 1 to 6, the following self checking code is generated:

| // checkpoint 1 | |
|---|---|
| EnterCheckpointPrivilege( ) | |
| // initialize registers | |
| LI(s6, | 0x23d1fca9) |
| LI(s2, | 0xe62af518) |
| LI(t4, | 0x062a3cb1) |
| // initialize memory | |
| LI | (v1,(0x01066284 + 0x80000000)) |
| LI | (t6, 0xbd91075f) |
| sw | t6, 0(v1) |
| // generate tlb entry | |
| LI | (v1, 0x0000001a) |
| mtc0 | v1, C0_Index |
| LI | (v1, 0x00000000) |
| mtc0 | v1, C0_PageMask |
| LI | (v1, 0x60366000) |
| mtc0 | v1, C0_EntryHi |
| LI | (v1, 0x0004199e) |
| mtc0 | v1, C0_EntryLo0 |
| LI | (v1, 0x000419de) |
| mtc0 | v1, C0_EntryLo1 |
| ehb | |
| tlbwi | |
| ehb | |
| ExitCheckpointPrivilege( ) | |
| // random instructions to test | |
| add | t0, s6, s2 |
| mul | t8, t4, t0 |
| lw | t7, 19(t8) |
| // checkpoint 2 | |
| EnterCheckpointPrivilege( ) | |
| // testing t0 | |
| LI | (t6, 0x09fcf1c1) |
| bne | t0, t6, Fail |
| nop | |
| // testing t8 | |
| LI | (t6, 0x60366271) |
| bne | t8, t6, Fail |
| nop | |
| // testing t7 | |
| LI | (t6, 0xbd91075f) |
| bne | t7, t6, Fail |
| nop | |

ExitCheckpointPrivilege( )

The routines EnterCheckpointPrivilege( ) and ExitCheckpointPrivilege( ) are assembler macros that acquire or relinquish the necessary privilege level required to carry out the instructions in the checkpoint (for example, to access unmapped memory segments or write a TLB entry). These routines are included in the verification program to allow the program to be executed without hindrance.

As can be seen from the illustrative example given above, the embodiment provides a system, method and software application that can create complex, interesting, self checking and sturdy verification programs in an automated manner. While the user can choose the types, mix and order of instructions, the generation of instructions, the generation of appropriate register and memory reference values, the insertion of checkpoints and the gathering and reporting of results is automated through the use of the SRVP software application. This allows the user to better test CPU designs.

Moreover, the SRVP framework is largely independent of the architecture of any particular CPU design. This allows the framework to be utilized to generate randomly generated self-checking verification programs for any CPU architecture and any CPU instruction set, providing the appropriate templates and simulator are available.

In one aspect, the present invention provides a method for the generation of a verification program for a CPU, comprising randomly generating at least one instruction executable on the CPU, providing the randomly generated instruction to a CPU simulator, whereby the simulator returns a status of the CPU after the instruction has been executed and a suggestion for change of a prior state of the CPU to modify the effect of the at least one instruction.

The method may comprise classifying the status of the at least one instruction into a type and the status may be selected from the group consisting of a normal type, a branch type, an exception type and an unpredictable type.

If the status is of a normal type, the at least one instruction may be written to the verification program.

If the status of the instruction is unpredictable, the status may be reported to a user, or change information arranged to render the instruction predictable may be determined. The change information may be inserted into the verification program to render the at least one instruction predictable.

The change information may take the form register setting code arranged to set at least one register prior to the execution of the at least one instruction and/or memory mapping information arranged to set at least one memory address to be referenced by the at least one instruction. The simulator preferably determines the change information.

If the status of the instruction is a branch, branch handling instructions may be inserted into the verification program. Alternatively, if the status of the instruction is an exception, exception handling instructions may be inserted into the verification program.

At least one instruction (such as a checkpoint) arranged to return the status of the CPU may also be inserted into the verification program. The CPU may be a central processing unit, which may utilize a MIPS instruction set.

In a second aspect, the invention provides a method for generating a verification program for a CPU, comprising the further step of receiving input regarding a plurality of instruction types, randomly generating at least one instruction executable on the CPU for each of the plurality of instruction types, providing each of the at least one randomly generated instruction to a CPU simulator, whereby the simulator returns the expected status of the CPU after the each at least one instruction has been executed.

In a third aspect, the invention provides a system for the generation of a verification program for a CPU, comprising a generator arranged to generate at least one instruction executable on the CPU, and a simulator arranged to receive the randomly generated instruction, wherein the simulator returns the status of the CPU after the instruction has been executed.

In a fourth aspect, the invention provides a randomly generated software application arranged to verify the operation of a CPU, comprising at least one randomly generated instruction and at least one checkpoint arranged to verify the status of the circuit once the randomly generated instruction has been executed.

In a fifth aspect, the invention provides a computer program arranged to, when executed on a computing system, perform the method steps in accordance with a first aspect of the invention.

In a sixth aspect, the invention provides a computer readable medium containing a computer program in accordance with a fifth aspect of the invention.

In the embodiments described herein, a SRVP is a program written in the MIPS assembly language (instruction set). The SRVP is capable of being executed on any MIPS compatible CPU (whether hardware or simulation). It will be understood, however, that the embodiments (and the broader invention) described herein may be utilized to construct a verification program for any type of CPU or integrated circuit. The SRVP code (as described above) is structured in a way that is designed to make construction of different types of tests simple and flexible. As the instructions are drawn from a template of available instructions, a person skilled in the art may easily adapt the embodiment described herein to construct a verification program for any type of CPU, by changing the instruction set contained in the template and by changing the simulator. Such variations and modifications are within the purview of a person skilled in the art.

We claim:

1. A method for the generation of a verification program for a central processing unit (CPU), comprising randomly generating at least one instruction executable on the CPU, providing the randomly generated instruction to a CPU simulator, whereby the simulator returns both a status of the CPU after the instruction has been executed and a suggestion for change of a prior state of the CPU to modify the effect of the at least one instruction.

2. The method in accordance with claim 1, further comprising classifying the status of the at least one instruction into a type.

3. The method in accordance with claim 1, further comprising selecting the status of the instruction type from the group consisting of a normal type, a branch type, an exception type and an unpredictable type.

4. The method in accordance with claim 3, further comprising, if the status is of a normal type, writing the at least one instruction to the verification program.

5. A method in accordance with claim 4, further comprising, if the status of the at least one instruction is unpredictable, determining change information arranged to render the instruction predictable.

6. The method in accordance with claim 4, further comprising, inserting change information into the verification program to render the at least one instruction predictable.

7. The method in accordance with claim 6, whereby inserting the change information includes inserting register setting code to set at least one register prior to the execution of the at least one instruction.

8. The method in accordance with claim 7, whereby inserting change information includes inserting memory mapping information to set at least one memory address to be referenced by the at least one instruction.

9. The method in accordance with claim 8, whereby the memory address is one of a physical and a virtual address.

10. The method in accordance with claim 4, further comprising, if the status of the instruction is a branch, inserting branch handling instructions into the verification program.

11. The method in accordance with claim 4, further comprising, if the status of the instruction is an exception, inserting exception handling instructions into the verification program.

12. The method in accordance with claim 1, further comprising inserting into the verification program at least one instruction arranged to return the status of the CPU.

13. The method in accordance with claim 1, whereby the CPU utilizes a MIPS instruction set.

14. A system for the generation of a verification program for a CPU, comprising a generator arranged to generate at least one instruction executable on the CPU, and a simulator arranged to receive the randomly generated instruction, wherein the simulator returns a status of the CPU after the instruction has been executed and a suggestion for change of a prior state of the CPU to modify the effect of the at least one instruction.

15. A system in accordance with claim 14, further comprising a classifying module arranged to classify the status of the at least one instruction as one of a normal type, a branch type, an exception type and an unpredictable type.

16. A system in accordance with claim 14, further comprising a writing module arranged to, if the status is of a normal type, write the at least one instruction to the verification program.

17. A system in accordance with claim 14, further comprising a reporting module arranged to, if the status of the instruction is unpredictable, determine change information arranged to render the instruction predictable.

18. A system in accordance with claim 17, wherein the change information module causes the change information to be inserted into the verification program to render the at least one instruction predictable.

19. A system in accordance with claim 17, wherein the change information includes register setting code arranged to set at least one register prior to the execution of the at least one instruction.

20. A system in accordance with claim 17, wherein the change information includes memory mapping information to set at least one memory address to be referenced by the at least one instruction.

21. A system in accordance with claim 20, wherein the memory address is one of a physical and a virtual address.

22. A system in accordance with claim 21, wherein the change information includes, if the status of the instruction is a branch, branch handling instructions.

23. A system in accordance with claim 21, wherein the change information includes, if the status of the instruction is an exception, exception handling instructions.

24. A system in accordance with claim 14, further comprising a checkpoint module arranged to insert into the verification program at least one instruction arranged to return the status of the CPU.

25. A system in accordance with claim 24, wherein the checkpoint module executes at a privilege level different from the privilege level of the at least one instruction.

26. A randomly generated program arranged to verify the operation of a CPU, comprising at least one randomly generated instruction and at least one checkpoint arranged to verify the status of the CPU once the randomly generated instruction has been executed.

27. The randomly generated program of claim 26 further comprising a plurality of random instructions associated with a plurality of threads for verifying multiple threads of execution.

28. The randomly generated software application of claim 27 further comprising synchronizing instructions suggested by the simulator to generate predictable results.

29. The randomly generated software application of claim 26 further comprising creating a plurality of random instructions for concurrently verifying the operation of at least one additional CPU.

30. The randomly generated software application of claim 27 further comprising synchronizing instructions suggested by the simulator to generate predictable results.

31. A method for verifying the architecture of a CPU comprising randomly generating a plurality of executable instructions that include at least one load instruction or one store instruction that access a random value in a base register to determine the memory location for the load or store operation wherein:
if a physical address (PA) is being read from for the first time, inserting code to initialize the memory location at the physical address to a known value;
if a virtual address (VA) is mapped by a translation lookaside buffer (TLB), and there is no corresponding valid entry in the TLB at the time the instruction is executed, inserting code in a prior checkpoint to populate the TLB, and mapping the load to an available PA;
selecting an immediate offset value in a load or store instruction to align the computed VA; and
if the VA is unmapped, discarding the load instruction if the PA is in a region of memory otherwise required by the test.

32. The method of claim 31 further comprising selecting an immediate offset for a load or a store instruction to tune the number of alignment exceptions and to cause load and store instructions to access a selected subset of cache lines.

33. The method of claim 31 wherein the value in the base register is generated by a prior sequence of instructions.

34. A computer readable medium containing executable instructions that implement the method in accordance with claim 31.
